(19) United States
(12) Patent Application Publication
(10) Pub. No.: US 2020/0104758 A1
(43) Pub. Date: Apr. 2, 2020

(54) Lodging Reservation System and Methods of Use

(71) Applicant: Guestbook Rewards, Inc., West Hollywood, CA (US)

(72) Inventor: James Jeffrey Gancos, West Hollywood, CA (US)

(73) Assignee: Guestbook Rewards, Inc., West Hollywood, CA (US)

(21) Appl. No.: 16/492,105

(22) PCT Filed: Apr. 10, 2018
(86) PCT No.: PCT/US2018/026984

§ 371 Date: Sep. 6, 2019

Related U.S. Application Data
(60) Provisional application No. 62/484,798, filed on Apr. 12, 2017.

(51) Int. Cl. G06Q 10/02

(52) U.S. Cl. CPC G06Q 10/02

(57) ABSTRACT

A lodging reservation system and associated methods are configured for incentivizing an at least user to book a reservation directly with a given lodging facility rather than through a third party booking agent. In at least one embodiment, upon the user desiring to book a reservation at a desired lodging facility, a lowest bookable third party rate for the desired lodging facility is obtained, as provided by the third party booking agent. A lowest bookable direct rate for the desired lodging facility is also determined. A difference between the lowest bookable direct rate and the lowest bookable third party rate is calculated. A cost-effective incentive offer to add to the discovered lowest bookable direct rate is determined. The incentive offer is dynamically modified to better correspond to said user and the desired reservation.

### RELATED APPLICATIONS

This application claims priority and is entitled to the filing date of U.S. provisional application Ser. No. 62/484,798, filed on Apr. 12, 2017. The contents of the aforementioned application(s) are incorporated herein by reference.

### BACKGROUND

The subject of this patent application relates generally to lodging reservation systems, and more particularly to a lodging reservation system and associated methods of use configured for incentivizing lodging guests to book stays directly with a given lodging facility rather than through a third party booking agent.

Applicant hereby incorporates herein by reference any and all patents and published patent applications cited or referred to in this application.

By way of background, third party booking agents and merchants (i.e., third parties that assist customers with booking various types of reservations related to lodging, travel, dining, etc.)—hereinafter referred to generally as “third party booking agents” for simplicity purposes—have been steadily on the rise, thus reducing the number of reservations being made directly with a given lodging facility, alternative accommodation supplier, airline, rental car company, cruise line, travel company, or eatery. Accordingly, a need exists in the lodging industry for a system and associated methods for incentivizing lodging guests to book stays directly with a given lodging facility rather than through a third party booking agent.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a lodging reservation system and associated methods for incentivizing an at least one user to book stays directly with a given lodging facility rather than through a third party booking agent. In at least one embodiment, upon the user desiring to book a reservation at a desired lodging facility, a lowest bookable third party rate for the desired lodging facility is obtained, as provided by the third party booking agent. Additionally, a lowest bookable direct rate for the desired lodging facility is determined, as provided directly by said lodging facility, based on an at least one desired stay parameter provided by said user. A difference between the lowest bookable direct rate and the lowest bookable third party rate is calculated. A cost-effective incentive offer to add to the discovered lowest bookable direct rate is determined in order to encourage said user to book the stay directly through the desired lodging facility rather than the third party booking agent. The incentive offer is dynamically modified to better correspond to said user and the desired reservation. The user is presented with a cost comparison between booking the desired reservation via the third party booking agent and the desired lodging facility directly via a display screen of an at least one user device in said user's possession. A hyperlink is provided via the at least one user device that allows said user to navigate to a website of the desired lodging facility to complete the reservation booking.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary lodging reservation system, in accordance with at least one embodiment;

FIG. 2 is an architecture diagram of an exemplary user account, in accordance with at least one embodiment; and

FIGS. 3-5 are flow diagrams of exemplary methods for administering the lodging reservation system, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

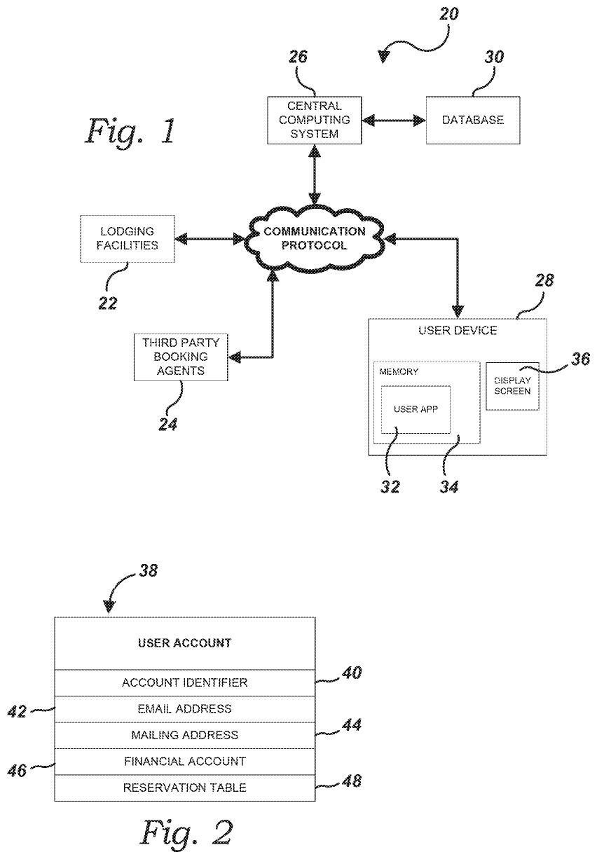

Turning now to FIG. 1, there is shown a simplified schematic view of an exemplary lodging reservation system 20 configured for incentivizing an at least one potential lodging guest (hereinafter referred to as a “user”) to book stays directly with a given lodging facility 22 rather than through a third party booking agent 24, in accordance with at least one embodiment. In at least one embodiment, the system 20 provides a central computing system 26 configured for receiving and processing data related to the at least one user and an associated at least one reservation, along with each of the participating lodging facilities 22. An at least one user device 28 is in selective communication with the computing system 26. Additionally, in at least one embodiment, an at least one database 30 is in communication with the computing system 26 and configured for selectively storing said data related to the at least one user and associated at least one reservation, along with each of the participating lodging facilities 22. Additionally, in at least one embodiment, at least one of the computing system 26 and at least one user device 28 is in selective communication with the each of the third party book agents 24 and participating lodging facilities 22. In at least one embodiment, the computing system 22 and database 30 are one and the same—as such, it is intended that those terms as used herein are to be interchangeable with one another. In at least one embodiment, the computing system 26 and database 30 are omitted, such that the system 20 and associated methods described herein are implemented solely through the at least one user device 28—thus, any methods or functionality described herein as being carried out by the computing system 26 or database 30 may, in at least one embodiment, also be carried out by the at least one user device 28, regardless of whether such embodiments nevertheless incorporate the computing system 26 and/or database 30.

At the outset, it should be noted that communication between each of the computing system 26, at least one user device 28, and at least one database 30 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes. Similarly, in at least one embodiment, communications between each of the computing system 26, at least one user device 28, and at least one database 30 may be encrypted using any encryption method (or combination of methods) now known or later developed. It should also be noted that the term “user device” is intended to include any type of computing or electronic device, now known or later developed, capable of communicating with the computing system 26—such as desktop computers, browser extensions, mobile phones, smartphones, laptop computers, tablet computers, personal data assistants, gaming devices, wearable devices, etc. As such, the present invention should not be read as being limited to use with any one particular type of computing or electronic device, even though certain exemplary devices may be mentioned or shown herein for illustrative purposes.

With continued reference to FIG. 1, in the exemplary embodiment, each of the computing system 26, at least one user device 28, and at least one database 30 contains the hardware and software necessary to carry out the exemplary methods for administering the lodging reservation system 20, as described herein. Furthermore, in at least one embodiment, the computing system 26 comprises a plurality of computing devices selectively working in concert with one another to carry out the exemplary methods for administering the lodging reservation system 20, as described herein. In at least one embodiment, the at least one user device 28 provides a user application 32 residing locally in memory 34 on the user device 28 (either as a standalone application or as a browser extension for an existing Internet browser on the user device 28), the user application 32 being configured for selectively communicating with the computing system 26, as discussed further below. It should be noted that the term “memory” is intended to include any type of electronic storage medium (or combination of storage mediums) now known or later developed, such as local hard drives, RAM, flash memory, secure digital (“SD”) cards, external storage devices, network or cloud storage devices, integrated circuits, etc. Additionally, in at least one embodiment, each of the at least one user device 28 is in the possession of a user who is desirous of utilizing the system 20 to obtain the best price for a given reservation at the at least one lodging facility 22.

Furthermore, the various components of the at least one user device 28 may reside on a single computing and/or electronic device, or may separately reside on two or more computing and/or electronic devices in communication with one another. In at least one embodiment, the functionality provided by the user application 32 resides remotely in memory on the computing system 26 and/or database 30, with the at least one user device 28 capable of accessing said functionality via an online portal hosted by the computing system 26 and/or database 30, either in addition to or in lieu of the user application 32 residing locally in memory 34 on the at least one user device 28. It should be noted that, for simplicity purposes, the functionality provided by the user application 32 will be described herein as such—even though certain embodiments may provide said functionality through an online portal. It should also be noted that, for simplicity purposes, when discussing functionality and the various methods that may be carried out by the system 20 herein, the terms “user device” and “user application” are intended to be interchangeable. With continued reference to FIG. 1, in at least one embodiment, the at least one user device 28 provides an at least one display screen 36 for providing an at least one graphical user interface to assist the associated user in possession of said user device 28 to access and utilize the various functions provided by the system 20.

In at least one embodiment, as illustrated in the architecture diagram of FIG. 2, the computing system 26—or the at least one database 30—stores and manages a user account 38 for each user containing various details related to the user and each of the at least one reservation associated with the user—i.e., each reservation that has been booked by the user through the system 20. In at least one embodiment, each user account 38 contains at least one of a unique account identifier 40 (such as an alphanumeric username or email address, for example), an email address 42 belonging to the associated user, a mailing address 44 belonging to the associated user, a financial account 46 belonging to the associated user (such as a bank account or PayPal® account, for example), and a reservation table 48 containing details related to each of the at least one reservation that has been booked by the associated user through the system 20. It should be noted that while the term “table” is used herein to describe certain exemplary data structures, in at least one embodiment, any other suitable data type or data structure, or combinations thereof, now known or later developed, capable of storing the appropriate data, may be substituted. Thus, the present invention should not be read as being so limited.

As discussed in detail below, the system 20 may be utilized in a variety of contexts. For illustrative purposes, in each such context described herein, the system 20 is configured for incentivizing the at least one user to book a stay directly with a given participating lodging facility 22 rather than through a third party booking agent 24. However, in further embodiments, the system 20 may be utilized in other non-lodging-related industries, such as for incentivizing the at least one user to book a travel reservation or dining reservation directly with a given participating travel provider or eatery rather than through a third party booking agent. As such, the system 20 and associated methods described herein should not be read as being so limited, but instead can be utilized in any context, now known or later conceived, where providing such incentives is desired.

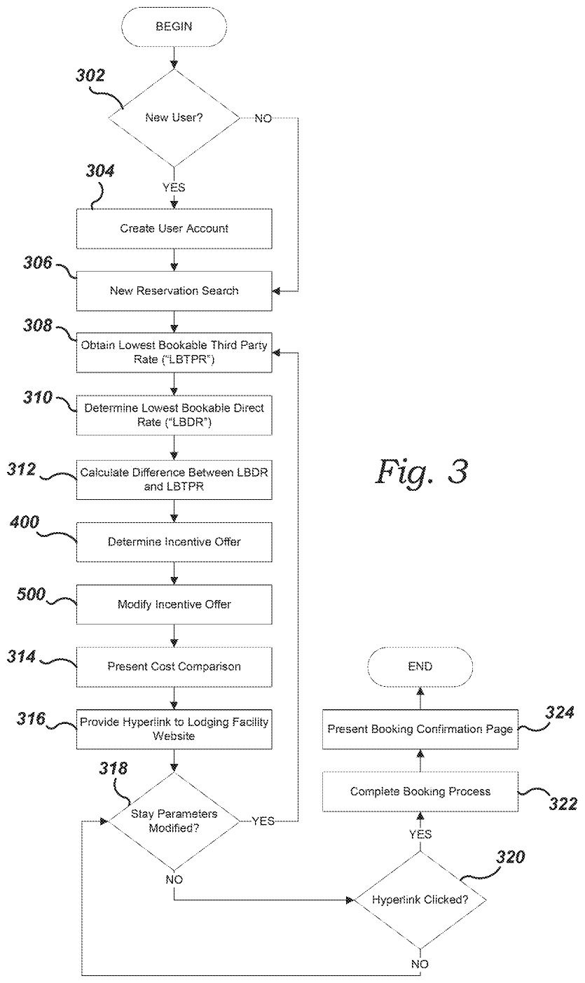

In at least one embodiment, as illustrated in the flow diagram of FIG. 3, through the user application 32 residing either locally in memory 34 on the at least one user device 28 or remotely on the computing system 26 and/or database 30, upon the associated user desiring to utilize the system 20 to book a stay at a participating lodging facility 22, the computing system 26 first determines whether the associated user is new to the system 20 (302). If the associated user is new, the user is required to properly register a new user account 38 with the computing system 26 via the user device 28 (304)—or, alternatively, via any other computing or electronic device capable of communicating with the computing system 26. In at least one embodiment, upon the user searching for a potential lodging stay through a third party booking agent 24 (i.e., via a third party booking website or search engine, for example) based on the user's desired stay parameters (i.e., one or more of a desired location, a desired arrival date, a desired departure date, a desired number of guests, a desired price range, a desired user-based or facility-based rating, etc.), and selecting at least one desired lodging facility 22 for potential booking (306), the user application 32 determines that the user is viewing potential lodging stays through a third party booking agent 24 (as opposed to the desired lodging facility's 22 direct website). In at least one embodiment, the user application 32 obtains a lowest bookable third party rate (“LBTPR”) for the desired lodging facility 22 as provided by the third party booking agent 24 (308), and then determines a lowest bookable direct rate (“LBDR”) for the desired lodging facility 22 as provided directly by said lodging facility 22 (310). In at least one such embodiment, the lowest bookable direct rate for the desired lodging facility 22 is obtained from the lodging facility's 22 direct booking website, which may be determined through a combination of previously populated lookup tables (containing a list of previously mapped hotel direct booking websites, for example), or a run-time logic using location data (such as a geographic search on a business listing database, for example), third party APIs, and web page crawling, or any other method now known or later developed. In at least one further embodiment, even if the user application 32 determines that the user is viewing potential lodging stays directly through the desired lodging facility's 22 website, the user application 32 nevertheless obtains a lowest bookable third party rate for the desired lodging facility 22 for comparison purposes, by searching all available bookable third party rates. In at least one such embodiment, the user application 32 may determine that the user had previously consulted with or was previously influenced by a third party booking agent 24 with respect to the user's current reservation search. In at least one embodiment, the user application 32 determines the lowest bookable direct rate by querying the at least one database (or screen scrape, etc.) 30 and/or third party databases to find other rates associated with the desired lodging facility 22 based on the user's desired stay parameters. In at least one such embodiment, the user application 32 searches both publicly available rates as well as rates that are only available through special codes or credentials.

With continued reference to FIG. 3, the user application 32 calculates the difference between the discovered lowest bookable direct rate and the lowest bookable third party rate (312). In at least one such embodiment, the user application 32 also notes any differences in the respective cancellation policies between the desired lodging facility 22 and the third party booking agent 24 (e.g., cancellable vs. non-cancellable, etc.). In at least one embodiment, should the user application 32 be unable to locate the lodging facility's 22 website or the lowest bookable direct rate on the lodging facility's 22 website, the user application 32 assumes the lowest bookable direct rate is equal to the lowest bookable third party rate for display purposes, but then requires a check by a person to determine the actual rate and corresponding incentive (as discussed further below) before sending the final offer back to the user. The user application 32 next determines a cost-effective incentive offer (if any) to add to the discovered lowest bookable direct rate (400)—by way of either a reward/rebate or a discount in the amount of the incentive offer—in order to encourage the user to book the stay directly through the desired lodging facility 22 rather than the third party booking agent 24. In at least one embodiment, the incentive offer may comprise one or more of a cash reward or rebate, a cash discount applied toward the booking, additional points in a select loyalty program, a free room upgrade, money or a discount that may be used toward select goods or services (such as food, travel or entertainment, for example), or any other cash-based or non-cash-based incentive now known or later conceived.

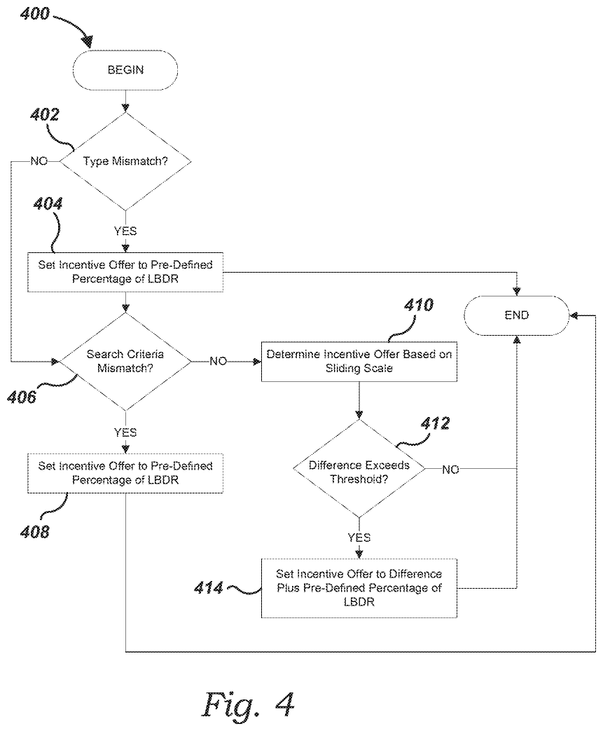

In a bit more detail, as illustrated in FIG. 4, in at least one embodiment, determining a cost-effective incentive offer first involves determining whether there is a type mismatch between the discovered lowest bookable direct rate and the lowest bookable third party rate (402)—namely, whether one of said rates is associated with a booking that can be cancelled at no charge and the other of said rates is associated with a booking that cannot be cancelled. If there is a type mismatch between the discovered lowest bookable direct rate and the lowest bookable third party rate, the user application 32 sets the incentive offer to a pre-defined percentage of the lowest bookable direct rate (404), such as 5% of the lowest bookable direct rate for example. Should the user application 32 determine that there is a search criteria mismatch between the discovered lowest bookable direct rate and the lowest bookable third party rate (406)—namely, where the user has modified their search criteria between the third party booking agent 24 website and the desired lodging facility's 22 direct website—the user application 32 sets the incentive offer to a pre-defined percentage of the lowest bookable direct rate (408), such as 5% of the lowest bookable direct rate for example.

Otherwise, in at least one embodiment, the user application 32 determines the cost-effective incentive offer amount using a pre-defined sliding scale based on the calculated difference between the discovered lowest bookable direct rate and the lowest bookable third party rate (410). An example of such a sliding scale is represented in the table below for illustrative purposes (i.e., the noted differences and incentive offer amounts are merely exemplary).

Incentive Offer Sliding Scale

| LBDR Is: | Incentive Offer Amount |
|---|---|
| 5% Higher than LBTPR | 10% of LBDR |
| 4% Higher than LBTPR | 9% of LBDR |
| 3% Higher than LBTPR | 8% of LBDR |
| 2% Higher than LBTPR | 7% of LBDR |
| 1% Higher than LBTPR | 6% of LBDR |
| Same as LBTPR | 5% of LBDR |
| 1% Lower than LBTPR | 5% of LBDR |
| 2% Lower than LBTPR | 5% of LBDR |
| 3% Lower than LBTPR | 5% of LBDR |
| 4% Lower than LBTPR | 5% of LBDR |
| 5% Lower than LBTPR | 5% of LBDR |
| 6% Lower than LBTPR | 4% of LBDR |
| 7% Lower than LBTPR | 3% of LBDR |
| >7% Lower than LBTPR | 3% of LBDR |

With continued reference to the exemplary Incentive Offer Sliding Scale table above, in at least one embodiment, if the calculated difference between the discovered lowest bookable direct rate and the lowest bookable third party rate exceeds a pre-defined maximum threshold (412) (e.g., if the LBDR is more than 5% higher than the LBTPR in the above exemplary table), the user application 32 sets the incentive offer to the calculated difference between the discovered lowest bookable direct rate and the lowest bookable third party rate plus a pre-defined percentage of the lowest bookable direct rate (414)—such as 5% of the lowest bookable direct rate for example. Otherwise, referring again to FIG. 3, in at least one embodiment, if the calculated difference between the discovered lowest bookable direct rate and the lowest bookable third party rate is less than the maximum threshold, such that the incentive offer amount is set using the above-discussed pre-defined sliding scale, the user application 32 next dynamically modifies the incentive offer to better suit the associated user (500), so as to further encourage the user to book the stay directly through the desired lodging facility 22 rather than the third party booking agent 24.

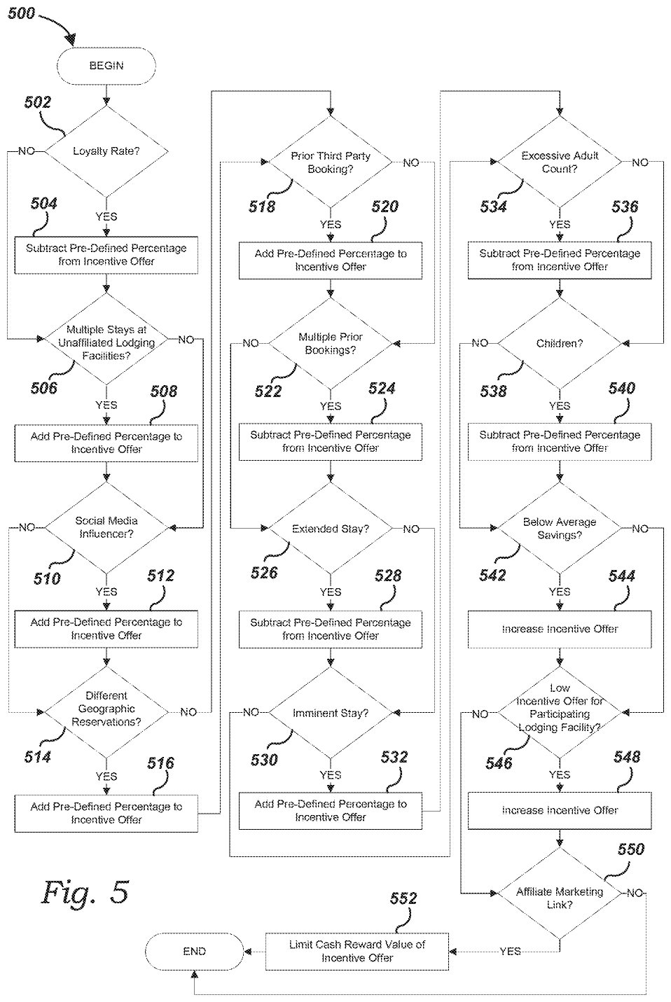

In at least one such embodiment, as illustrated in FIG. 5, upon determining that the lowest bookable direct rate is a loyalty rate associated with a loyalty membership of which the user is a member (502), and the user has made more than one booking via the system 20 using that particular loyalty rate or has at least saved their loyalty membership credentials within their user account 38, the user application 32 subtracts a pre-defined percentage from the incentive offer amount (504)—such as 1% for example. In at least one embodiment, upon determining that the user has booked stays at two or more different and unaffiliated lodging facilities in the past (506), the user application 32 adds a pre-defined percentage to the incentive offer amount (508)—such as 1% for example. In at least one embodiment, upon determining that the user has a social media following with an engagement level that exceeds a pre-defined influence threshold (such as being in the top 5% of all users on the particular social media platform for example) (510), the user application 32 adds a pre-defined percentage to the incentive offer amount (512)—such as 1% for each engagement level percentage above the pre-defined influence threshold for example. In at least one embodiment, upon determining that the user has previously booked stays at lodging facilities 22 in different geographic regions during a pre-defined period, where the number of such bookings exceeds a pre-defined threshold (such as booking stays in five or more cities within the past two months for example) (514), the user application 32 adds a pre-defined percentage to the incentive offer amount (516)—such as 1% for each such booking above the pre-defined threshold for example. In at least one such embodiment, upon determining that the user's previous booking was through a third party booking agent 24, despite having been offered a better deal via the system 20 (518), the user application 32 adds a pre-defined percentage to the incentive offer amount (520)—such as 1% for each such consecutive prior booking through a third party booking agent 24, for example, until the user ultimately decides to book a stay through a desired lodging facility 22 directly. In at least one such embodiment, upon determining that the user has previously booked a consecutive number of stays via the system 20 that exceeds a pre-defined threshold (such as booking the last three stays, for example) (522), the user application 32 subtracts a pre-defined percentage from the incentive offer amount (524)—such as 1% for example. In at least one embodiment, upon determining that the user is desirous of booking a stay lasting a number of nights that exceeds a pre-defined threshold (such as six nights, for example) (526), the user application 32 subtracts a pre-defined percentage from the incentive offer amount (528)—such as 2% for example. In at least one embodiment, upon determining that the user is desirous of booking a stay having an imminent arrival date that falls within a pre-defined window of time (such as within the next 24 or 48 hours, for example) (530), the user application 32 adds a pre-defined percentage to the incentive offer amount (532)—such as 1% for example. In at least one embodiment, upon determining that the user is desirous of booking a stay where the desired number of guests includes a ratio of adults per room that exceeds a pre-defined threshold (such as three adults per room, for example) (534), the user application 32 subtracts a pre-defined percentage from the incentive offer amount (536)—such as 0.5% for each adult guest for example. In at least one embodiment, upon determining that the user is desirous of booking a stay where the desired number of guests includes a ratio of children per room that exceeds a pre-defined threshold (such as one child per room, for example) (538), the user application 32 subtracts a pre-defined percentage from the incentive offer amount (540)—such as 1% for each child guest for example.

In at least one such embodiment, upon determining that a pre-defined number of previous bookings via the system 20 by the user (such as the last three bookings, for example) resulted in an average savings—factoring in both the calculated difference between the discovered lowest bookable direct rate and the lowest bookable third party rate as well as any incentive offer amounts—that falls below a pre-defined threshold (such as 5%, for example) (542), the user application 32 increases the incentive offer amount to equal the pre-defined threshold (544). In at least one such embodiment, upon determining that the desired lodging facility 22 is a participating lodging facility 22 and the incentive offer amount falls below a pre-defined threshold (such as 5%, for example) (546), the user application 32 increases the incentive offer amount to equal the pre-defined threshold (548). In at least one embodiment, upon determining that the system 20 is utilizing an affiliate marketing link to monetize the booking (550), the user application 32 limits any cash reward value of the incentive offer amount to a pre-defined value (552)—such as 0.5% lower than the affiliate marking amount received by the system 20, for example. It should be noted that these various steps for dynamically modifying the incentive offer may not necessarily all be carried out in any given embodiment. In at least one embodiment, only a subset of these steps for modifying the incentive offer are carried out. In at least one alternate embodiment, one or more of the above-described steps involving adding a pre-defined percentage to the incentive offer could be modified to instead subtract the pre-defined percentage from the incentive offer. Likewise, in at least one alternate embodiment, one or more of the above-described steps involving subtracting a pre-defined percentage from the incentive offer could be modified to instead add the pre-defined percentage to the incentive offer. Furthermore, in at least one alternate embodiment, further steps for modifying the incentive offer—now known or later developed—may be carried out by the system 20.

Referring again to FIG. 3, in at least one embodiment, after dynamically modifying the incentive offer (500), the user application 32 presents the user with the cost comparison between booking the desired stay via the third party booking agent 24 and the desired lodging facility 22 directly, including the added incentive offer, via the display screen 36 of the at least one user device 28 (314). In at least one such embodiment, the cost comparison includes any difference in cancellation policies, as discussed above. The user application 32 also provides a hyperlink that allows the user to navigate to the desired lodging facility's 22 website to complete the booking process, with all of the necessary items of information being pre-populated by the user application 32 (316), including the user's loyalty membership credentials where available. In at least one embodiment, in the event the user subsequently modifies the desired stay parameters (318), the user application 32 repeats steps 302-316 above. In at least one embodiment, once the user clicks the provided hyperlink (320) and completes the booking (322), the user application 32 presents the user with a booking confirmation page containing select details related to the booked stay, along with a final comparison between the booking costs and what the user would have paid through the third party booking agent 24 (324). In at least one embodiment, the necessary details related to the stay are also stored within the system 20 for tracking the user's stay, fulfilling any incentive offers, and calculating incentive offers associated with future potential bookings.

Aspects of the present specification may also be described as follows:

1. A method for administering a lodging reservation system for incentivizing an at least user to book a reservation directly with a given lodging facility rather than through a third party booking agent, the method comprising the steps of: implementing a central computing system configured for receiving and processing data related to the at least one user and an associated at least one reservation; establishing a user account associated with a one of the at least one user via a user device under the control of the at least one user and in selective communication with the computing system, the user account containing at least one of a unique account identifier and a reservation table containing details related to each of the at least one reservation that has been booked by the associated user through the system; and upon a one of the at least one user desiring to book a reservation at a desired lodging facility: obtaining a lowest bookable third party rate for the desired lodging facility as provided by the third party booking agent; determining a lowest bookable direct rate for the desired lodging facility, as provided directly by said lodging facility, based on an at least one desired stay parameter provided by said user; calculating a difference between the lowest bookable direct rate and the lowest bookable third party rate; determining a cost-effective incentive offer to add to the discovered lowest bookable direct rate in order to encourage said user to book the stay directly through the desired lodging facility rather than the third party booking agent; dynamically modifying the incentive offer to better correspond to said user and the desired reservation; presenting said user with a cost comparison between booking the desired reservation via the third party booking agent and the desired lodging facility directly via the display screen of the at least one user device; and providing a hyperlink via the at least one user device that allows said user to navigate to a website of the desired lodging facility to complete the reservation booking.

2. The method according to embodiment 1, further comprising the step of implementing an at least one database in communication with the computing system and configured for selectively storing said data related to the at least one user and associated at least one reservation.

3. The method according to embodiments 1-2, wherein the step of determining a lowest bookable direct rate further comprises the steps of querying the at least one database for other possible rates associated with the desired lodging facility based on said user's desired stay parameters.

4. The method according to embodiments 1-3, further comprising the step of implementing a user application residing in memory on at least one of the computing system and the at least one user device.

5. The method according to embodiments 1-4, further comprising the step of determining that said user is viewing potential lodging stays through a website provided by the third party booking agent.

6. The method according to embodiments 1-5, further comprising the step of presenting said user with a booking confirmation page via the display screen of the at least one user device containing select details related to the booked reservation, along with a final comparison between the booking costs and what said user would have paid through the third party booking agent.

7. The method according to embodiments 1-6, wherein the step of determining a cost-effective incentive offer further comprises the step of, upon determining that there is a type mismatch between the lowest bookable direct rate and the lowest bookable third party rate, setting the incentive offer to a pre-defined percentage of the lowest bookable direct rate.

8. The method according to embodiments 1-7, wherein the step of determining a cost-effective incentive offer further comprises the step of, upon determining that there is a search criteria mismatch between the lowest bookable direct rate and the lowest bookable third party rate, setting the incentive offer to a pre-defined percentage of the lowest bookable direct rate.

9. The method according to embodiments 1-8, wherein the step of determining a cost-effective incentive offer further comprises the step of setting the incentive offer using a pre-defined sliding scale based on the difference between the lowest bookable direct rate and the lowest bookable third party rate.

10. The method according to embodiments 1-9, further comprising the step of, upon determining that the difference between the lowest bookable direct rate and the lowest bookable third party rate exceeds a pre-defined maximum threshold, setting the incentive offer to equal the difference between the discovered lowest bookable direct rate and the lowest bookable third party rate plus a pre-defined percentage of the lowest bookable direct rate.

11. The method according to embodiments 1-10, wherein the step of dynamically modifying the incentive offer further comprises the step of, upon determining that the lowest bookable direct rate is a loyalty rate associated with a loyalty membership of which said user is a member, subtracting a pre-defined percentage from the incentive offer amount.

12. The method according to embodiments 1-11, wherein the step of dynamically modifying the incentive offer further comprises the step of, upon determining that said user has previously booked reservations at two or more different and unaffiliated lodging facilities adding a pre-defined percentage to the incentive offer amount.

13. The method according to embodiments 1-12, wherein the step of dynamically modifying the incentive offer further comprises the step of, upon determining that said user has a social media following with an engagement level that exceeds a pre-defined influence threshold adding a pre-defined percentage to the incentive offer amount.

14. The method according to embodiments 1-13, wherein the step of dynamically modifying the incentive offer further comprises the step of, upon determining that said user has previously booked reservations at lodging facilities in different geographic regions during a pre-defined period, where the number of such bookings exceeds a pre-defined threshold, adding a pre-defined percentage to the incentive offer amount.

15. The method according to embodiments 1-14, wherein the step of dynamically modifying the incentive offer further comprises the step of, upon determining that said user's previous reservation was booked through a third party booking agent, despite having been offered a better deal via the system, adding a pre-defined percentage to the incentive offer amount.

16. The method according to embodiments 1-15, wherein the step of dynamically modifying the incentive offer further comprises the step of, upon determining that said user has previously booked a consecutive number of reservations via the system that exceeds a pre-defined threshold, subtracting a pre-defined percentage from the incentive offer amount.

17. The method according to embodiments 1-16, wherein the step of dynamically modifying the incentive offer further comprises the step of, upon determining that said user is desirous of booking a reservation lasting a number of nights that exceeds a pre-defined threshold, subtracting a pre-defined percentage from the incentive offer amount.

18. The method according to embodiments 1-17, wherein the step of dynamically modifying the incentive offer further comprises the step of, upon determining that said user is desirous of booking a reservation having an imminent arrival date that falls within a pre-defined window of time, adding a pre-defined percentage to the incentive offer amount.

19. The method according to embodiments 1-18, wherein the step of dynamically modifying the incentive offer further comprises the step of, upon determining that said user is desirous of booking a reservation where a desired number of guests includes a ratio of adults per room that exceeds a pre-defined threshold, subtracting a pre-defined percentage from the incentive offer amount.

20. The method according to embodiments 1-19, wherein the step of dynamically modifying the incentive offer further comprises the step of, upon determining that said user is desirous of booking a reservation where a desired number of guests includes a ratio of children per room that exceeds a pre-defined threshold, subtracting a pre-defined percentage from the incentive offer amount.

21. The method according to embodiments 1-20, wherein the step of dynamically modifying the incentive offer further comprises the step of, upon determining that a pre-defined number of previous reservations booked by said user via the system resulted in an average savings that falls below a pre-defined threshold, increasing the incentive offer amount to equal the pre-defined threshold.

22. The method according to embodiments 1-21, wherein the step of dynamically modifying the incentive offer further comprises the step of, upon determining that the desired lodging facility is a participating lodging facility and the incentive offer amount falls below a pre-defined threshold, increasing the incentive offer amount to equal the pre-defined threshold.

23. The method according to embodiments 1-22, wherein the step of dynamically modifying the incentive offer further comprises the step of, upon determining that the system is utilizing an affiliate marketing link to monetize the reservation booking, limiting any cash reward value of the incentive offer amount to a pre-defined value.

24. A method for administering a lodging reservation system for incentivizing an at least user to book a reservation directly with a given lodging facility rather than through a third party booking agent, the method comprising the steps of: implementing a central computing system configured for receiving and processing data related to the at least one user and an associated at least one reservation; establishing a user account associated with a one of the at least one user via a user device under the control of the at least one user and in selective communication with the computing system, the user account containing at least one of a unique account identifier and a reservation table containing details related to each of the at least one reservation that has been booked by the associated user through the system; and upon a one of the at least one user desiring to book a reservation at a desired lodging facility: obtaining a lowest bookable third party rate for the desired lodging facility as provided by the third party booking agent; determining a lowest bookable direct rate for the desired lodging facility, as provided directly by said lodging facility, based on an at least one desired stay parameter provided by said user; calculating a difference between the lowest bookable direct rate and the lowest bookable third party rate; determining a cost-effective incentive offer to add to the discovered lowest bookable direct rate, using a pre-defined sliding scale based on the difference between the lowest bookable direct rate and the lowest bookable third party rate, in order to encourage said user to book the stay directly through the desired lodging facility rather than the third party booking agent; upon determining that the difference between the lowest bookable direct rate and the lowest bookable third party rate exceeds a pre-defined maximum threshold, setting the incentive offer to equal the difference between the discovered lowest bookable direct rate and the lowest bookable third party rate plus a pre-defined percentage of the lowest bookable direct rate; dynamically modifying the incentive offer to better correspond to said user and the desired reservation; presenting said user with a cost comparison between booking the desired reservation via the third party booking agent and the desired lodging facility directly via the display screen of the at least one user device; and providing a hyperlink via the at least one user device that allows said user to navigate to a website of the desired lodging facility to complete the reservation booking.

25. A lodging reservation system for incentivizing an at least user to book a reservation directly with a given lodging facility rather than through a third party booking agent, the system comprising: a central computing system configured for receiving and processing data related to the at least one user and an associated at least one reservation; an at least one user device under the control of the at least one user and in selective communication with the computing system; and a user account associated with a one of the at least one user, the user account containing at least one of a unique account identifier and a reservation table containing details related to each of the at least one reservation that has been booked by the associated user through the system; and upon a one of the at least one user desiring to book a reservation at a desired lodging facility, the system is configured for: obtaining a lowest bookable third party rate for the desired lodging facility as provided by the third party booking agent; determining a lowest bookable direct rate for the desired lodging facility, as provided directly by said lodging facility, based on an at least one desired stay parameter provided by said user; calculating a difference between the lowest bookable direct rate and the lowest bookable third party rate; determining a cost-effective incentive offer to add to the discovered lowest bookable direct rate in order to encourage said user to book the stay directly through the desired lodging facility rather than the third party booking agent; dynamically modifying the incentive offer to better correspond to said user and the desired reservation; presenting said user with a cost comparison between booking the desired reservation via the third party booking agent and the desired lodging facility directly via the display screen of the at least one user device; and providing a hyperlink via the at least one user device that allows said user to navigate to a website of the desired lodging facility to complete the reservation booking.

26. The lodging reservation system according to embodiment 25, further comprising an at least one database in communication with the computing system and configured for selectively storing said data related to the at least one user and associated at least one reservation.

27. The lodging reservation system according to embodiments 25-26, wherein the incentive offer comprises at least one of a cash reward or rebate, a cash discount applied toward the reservation, additional points in a select loyalty program, a free room upgrade, and money or a discount that may be used toward select goods or services.

28. The lodging reservation system according to embodiments 25-27, wherein while determining a lowest bookable direct rate, the system is further configured for querying the at least one database for other possible rates associated with the desired lodging facility based on said user's desired stay parameters.

29. The lodging reservation system according to embodiments 25-28, further comprising a user application residing in memory on at least one of the computing system and the at least one user device.

30. The lodging reservation system according to embodiments 25-29, wherein the system is further configured for determining that said user is viewing potential lodging stays through a website provided by the third party booking agent.

31. The lodging reservation system according to embodiments 25-30, wherein the system is further configured for presenting said user with a booking confirmation page via the display screen of the at least one user device containing select details related to the booked reservation, along with a final comparison between the booking costs and what said user would have paid through the third party booking agent.

32. The lodging reservation system according to embodiments 25-31, wherein while determining a cost-effective incentive offer, the system is further configured for, upon determining that there is a type mismatch between the lowest bookable direct rate and the lowest bookable third party rate, setting the incentive offer to a pre-defined percentage of the lowest bookable direct rate.

33. The lodging reservation system according to embodiments 25-32, wherein while determining a cost-effective incentive offer, the system is further configured for, upon determining that there is a search criteria mismatch between the lowest bookable direct rate and the lowest bookable third party rate, setting the incentive offer to a pre-defined percentage of the lowest bookable direct rate.

34. The lodging reservation system according to embodiments 25-33, wherein while determining a cost-effective incentive offer, the system is further configured for, setting the incentive offer using a pre-defined sliding scale based on the difference between the lowest bookable direct rate and the lowest bookable third party rate.

35. The lodging reservation system according to embodiments 25-34, wherein the system is further configured for, upon determining that the difference between the lowest bookable direct rate and the lowest bookable third party rate exceeds a pre-defined maximum threshold, setting the incentive offer to equal the difference between the discovered lowest bookable direct rate and the lowest bookable third party rate plus a pre-defined percentage of the lowest bookable direct rate.

36. The lodging reservation system according to embodiments 25-35, wherein while dynamically modifying the incentive offer, the system is further configured for, upon determining that the lowest bookable direct rate is a loyalty rate associated with a loyalty membership of which said user is a member, subtracting a pre-defined percentage from the incentive offer amount.

37. The lodging reservation system according to embodiments 25-36, wherein while dynamically modifying the incentive offer, the system is further configured for, upon determining that said user has previously booked reservations at two or more different and unaffiliated lodging facilities adding a pre-defined percentage to the incentive offer amount.

38. The lodging reservation system according to embodiments 25-37, wherein while dynamically modifying the incentive offer, the system is further configured for, upon determining that said user has a social media following with an engagement level that exceeds a pre-defined influence threshold adding a pre-defined percentage to the incentive offer amount.

39. The lodging reservation system according to embodiments 25-38, wherein while dynamically modifying the incentive offer, the system is further configured for, upon determining that said user has previously booked reservations at lodging facilities in different geographic regions during a pre-defined period, where the number of such bookings exceeds a pre-defined threshold, adding a pre-defined percentage to the incentive offer amount.

40. The lodging reservation system according to embodiments 25-39, wherein while dynamically modifying the incentive offer, the system is further configured for, upon determining that said user's previous reservation was booked through a third party booking agent, despite having been offered a better deal via the system, adding a pre-defined percentage to the incentive offer amount.

41. The lodging reservation system according to embodiments 25-40, wherein while dynamically modifying the incentive offer, the system is further configured for, upon determining that said user has previously booked a consecutive number of reservations via the system that exceeds a pre-defined threshold, subtracting a pre-defined percentage from the incentive offer amount.

42. The lodging reservation system according to embodiments 25-41, wherein while dynamically modifying the incentive offer, the system is further configured for, upon determining that said user is desirous of booking a reservation lasting a number of nights that exceeds a pre-defined threshold, subtracting a pre-defined percentage from the incentive offer amount.

43. The lodging reservation system according to embodiments 25-42, wherein while dynamically modifying the incentive offer, the system is further configured for, upon determining that said user is desirous of booking a reservation having an imminent arrival date that falls within a pre-defined window of time, adding a pre-defined percentage to the incentive offer amount.

44. The lodging reservation system according to embodiments 25-43, wherein while dynamically modifying the incentive offer, the system is further configured for, upon determining that said user is desirous of booking a reservation where a desired number of guests includes a ratio of adults per room that exceeds a pre-defined threshold, subtracting a pre-defined percentage from the incentive offer amount.

45. The lodging reservation system according to embodiments 25-44, wherein while dynamically modifying the incentive offer, the system is further configured for, upon determining that said user is desirous of booking a reservation where a desired number of guests includes a ratio of children per room that exceeds a pre-defined threshold, subtracting a pre-defined percentage from the incentive offer amount.

46. The lodging reservation system according to embodiments 25-45, wherein while dynamically modifying the incentive offer, the system is further configured for, upon determining that a pre-defined number of previous reservations booked by said user via the system resulted in an average savings that falls below a pre-defined threshold, increasing the incentive offer amount to equal the pre-defined threshold.

47. The lodging reservation system according to embodiments 25-46, wherein while dynamically modifying the incentive offer, the system is further configured for, upon determining that the desired lodging facility is a participating lodging facility and the incentive offer amount falls below a pre-defined threshold, increasing the incentive offer amount to equal the pre-defined threshold.

48. The lodging reservation system according to embodiments 25-47, wherein while dynamically modifying the incentive offer, the system is further configured for, upon determining that the system is utilizing an affiliate marketing link to monetize the reservation booking, limiting any cash reward value of the incentive offer amount to a pre-defined value.

In closing, regarding the exemplary embodiments of the present invention as shown and described herein, it will be appreciated that a lodging reservation system and associated methods of use are disclosed and configured for incentivizing lodging guests to book stays directly with a given lodging facility rather than through a third party booking agent. Because the principles of the invention may be practiced in a number of configurations beyond those shown and described, it is to be understood that the invention is not in any way limited by the exemplary embodiments, but is generally directed to a lodging reservation system and is able to take numerous forms to do so without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc. —for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment.

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for administering a lodging reservation system for incentivizing an at least user to book a reservation directly with a given lodging facility rather than through a third party booking agent, the method comprising the steps of:
implementing a central computing system configured for receiving and processing data related to the at least one user and an associated at least one reservation;
establishing a user account associated with a one of the at least one user via a user device under the control of the at least one user and in selective communication with the computing system, the user account containing at least one of a unique account identifier and a reservation table containing details related to each of the at least one reservation that has been booked by the associated user through the system; and
upon a one of the at least one user desiring to book a reservation at a desired lodging facility:
obtaining a lowest bookable third party rate for the desired lodging facility as provided by the third party booking agent;
determining a lowest bookable direct rate for the desired lodging facility, as provided directly by said lodging facility, based on an at least one desired stay parameter provided by said user;
calculating a difference between the lowest bookable direct rate and the lowest bookable third party rate;
determining a cost-effective incentive offer to add to the discovered lowest bookable direct rate in order to encourage said user to book the stay directly through the desired lodging facility rather than the third party booking agent;
dynamically modifying the incentive offer to better correspond to said user and the desired reservation;
presenting said user with a cost comparison between booking the desired reservation via the third party booking agent and the desired lodging facility directly via the display screen of the at least one user device; and
providing a hyperlink via the at least one user device that allows said user to navigate to a website of the desired lodging facility to complete the reservation booking.

2. The method of claim 1, wherein the step of determining a cost-effective incentive offer further comprises the step of, upon determining that there is a type mismatch between the lowest bookable direct rate and the lowest bookable third party rate, setting the incentive offer to a pre-defined percentage of the lowest bookable direct rate.

3. The method of claim 1, wherein the step of determining a cost-effective incentive offer further comprises the step of, upon determining that there is a search criteria mismatch between the lowest bookable direct rate and the lowest bookable third party rate, setting the incentive offer to a pre-defined percentage of the lowest bookable direct rate.

4. The method of claim 1, wherein the step of determining a cost-effective incentive offer further comprises the step of setting the incentive offer using a pre-defined sliding scale based on the difference between the lowest bookable direct rate and the lowest bookable third party rate.

5. The method of claim 9, further comprising the step of, upon determining that the difference between the lowest bookable direct rate and the lowest bookable third party rate exceeds a pre-defined maximum threshold, setting the incentive offer to equal the difference between the discovered lowest bookable direct rate and the lowest bookable third party rate plus a pre-defined percentage of the lowest bookable direct rate.

6. The method of claim 1, wherein the step of dynamically modifying the incentive offer further comprises the step of, upon determining that the lowest bookable direct rate is a loyalty rate associated with a loyalty membership of which said user is a member, subtracting a pre-defined percentage from the incentive offer amount.

7. The method of claim 1, wherein the step of dynamically modifying the incentive offer further comprises the step of, upon determining that said user has previously booked reservations at two or more different and unaffiliated lodging facilities adding a pre-defined percentage to the incentive offer amount.

8. The method of claim 1, wherein the step of dynamically modifying the incentive offer further comprises the step of, upon determining that said user has a social media following with an engagement level that exceeds a pre-defined influence threshold adding a pre-defined percentage to the incentive offer amount.

9. The method of claim 1, wherein the step of dynamically modifying the incentive offer further comprises the step of, upon determining that said user has previously booked reservations at lodging facilities in different geographic regions during a pre-defined period, where the number of such bookings exceeds a pre-defined threshold, adding a pre-defined percentage to the incentive offer amount.

10. The method of claim 1, wherein the step of dynamically modifying the incentive offer further comprises the step of, upon determining that said user's previous reservation was booked through a third party booking agent, despite having been offered a better deal via the system, adding a pre-defined percentage to the incentive offer amount.

11. The method of claim 1, wherein the step of dynamically modifying the incentive offer further comprises the step of, upon determining that said user has previously booked a consecutive number of reservations via the system that exceeds a pre-defined threshold, subtracting a pre-defined percentage from the incentive offer amount.

12. The method of claim 1, wherein the step of dynamically modifying the incentive offer further comprises the step of, upon determining that said user is desirous of booking a reservation lasting a number of nights that exceeds a pre-defined threshold, subtracting a pre-defined percentage from the incentive offer amount.

13. The method of claim 1, wherein the step of dynamically modifying the incentive offer further comprises the step of, upon determining that said user is desirous of booking a reservation having an imminent arrival date that falls within a pre-defined window of time, adding a pre-defined percentage to the incentive offer amount.

14. The method of claim 1, wherein the step of dynamically modifying the incentive offer further comprises the step of, upon determining that said user is desirous of booking a reservation where a desired number of guests includes a ratio of adults per room that exceeds a pre-defined threshold, subtracting a pre-defined percentage from the incentive offer amount.

15. The method of claim 1, wherein the step of dynamically modifying the incentive offer further comprises the step of, upon determining that said user is desirous of booking a reservation where a desired number of guests includes a ratio of children per room that exceeds a pre-defined threshold, subtracting a pre-defined percentage from the incentive offer amount.

16. The method of claim 1, wherein the step of dynamically modifying the incentive offer further comprises the step of, upon determining that a pre-defined number of previous reservations booked by said user via the system resulted in an average savings that falls below a pre-defined threshold, increasing the incentive offer amount to equal the pre-defined threshold.

17. The method of claim 1, wherein the step of dynamically modifying the incentive offer further comprises the step of, upon determining that the desired lodging facility is a participating lodging facility and the incentive offer amount falls below a pre-defined threshold, increasing the incentive offer amount to equal the pre-defined threshold.

18. The method of claim 1, wherein the step of dynamically modifying the incentive offer further comprises the step of, upon determining that the system is utilizing an affiliate marketing link to monetize the reservation booking, limiting any cash reward value of the incentive offer amount to a pre-defined value.

19. A method for administering a lodging reservation system for incentivizing an at least user to book a reservation directly with a given lodging facility rather than through a third party booking agent, the method comprising the steps of:
implementing a central computing system configured for receiving and processing data related to the at least one user and an associated at least one reservation;
establishing a user account associated with a one of the at least one user via a user device under the control of the at least one user and in selective communication with the computing system, the user account containing at least one of a unique account identifier and a reservation table containing details related to each of the at least one reservation that has been booked by the associated user through the system; and
upon a one of the at least one user desiring to book a reservation at a desired lodging facility:
obtaining a lowest bookable third party rate for the desired lodging facility as provided by the third party booking agent;
determining a lowest bookable direct rate for the desired lodging facility, as provided directly by said lodging facility, based on an at least one desired stay parameter provided by said user;
calculating a difference between the lowest bookable direct rate and the lowest bookable third party rate;
determining a cost-effective incentive offer to add to the discovered lowest bookable direct rate, using a pre-defined sliding scale based on the difference between the lowest bookable direct rate and the lowest bookable third party rate, in order to encourage said user to book the stay directly through the desired lodging facility rather than the third party booking agent;
upon determining that the difference between the lowest bookable direct rate and the lowest bookable third party rate exceeds a pre-defined maximum threshold, setting the incentive offer to equal the difference between the discovered lowest bookable direct rate and the lowest bookable third party rate plus a pre-defined percentage of the lowest bookable direct rate;
dynamically modifying the incentive offer to better correspond to said user and the desired reservation;
presenting said user with a cost comparison between booking the desired reservation via the third party booking agent and the desired lodging facility directly via the display screen of the at least one user device; and
providing a hyperlink via the at least one user device that allows said user to navigate to a website of the desired lodging facility to complete the reservation booking.

20. A lodging reservation system for incentivizing an at least user to book a reservation directly with a given lodging facility rather than through a third party booking agent, the system comprising:
a central computing system configured for receiving and processing data related to the at least one user and an associated at least one reservation;
an at least one user device under the control of the at least one user and in selective communication with the computing system; and
a user account associated with a one of the at least one user, the user account containing at least one of a unique account identifier and a reservation table containing details related to each of the at least one reservation that has been booked by the associated user through the system; and
upon a one of the at least one user desiring to book a reservation at a desired lodging facility, the system is configured for:
obtaining a lowest bookable third party rate for the desired lodging facility as provided by the third party booking agent;
determining a lowest bookable direct rate for the desired lodging facility, as provided directly by said lodging facility, based on an at least one desired stay parameter provided by said user;
calculating a difference between the lowest bookable direct rate and the lowest bookable third party rate;
determining a cost-effective incentive offer to add to the discovered lowest bookable direct rate in order to encourage said user to book the stay directly through the desired lodging facility rather than the third party booking agent;
dynamically modifying the incentive offer to better correspond to said user and the desired reservation;
presenting said user with a cost comparison between booking the desired reservation via the third party booking agent and the desired lodging facility directly via the display screen of the at least one user device; and
providing a hyperlink via the at least one user device that allows said user to navigate to a website of the desired lodging facility to complete the reservation booking.
